(19) United States
(12) Patent Application Publication
(10) Pub. No.: US 2010/0324915 A1
(43) Pub. Date: Dec. 23, 2010

(54) ENCODING AND DECODING APPARATUSES FOR HIGH QUALITY MULTI-CHANNEL AUDIO CODEC

(75) Inventors: Jeongil Seo, Daejeon (KR); Jae-Hyoun Yoo, Daejeon (KR); Kyeongok Kang, Daejeon (KR)

Correspondence Address: STAAS & HALSEY LLP, SUITE 700, 1201 NEW YORK AVENUE, N.W., WASHINGTON, DC, 20005, US

(73) Assignee: Electronic and Telecommunications Research Institute, Daejeon (KR)

(21) Appl. No.: 12/821,396

(22) Filed: Jun. 23, 2010

(30) Foreign Application Priority Data
Jun. 23, 2009 (KR) 10-2009-0055757
Dec. 4, 2009 (KR) 10-2009-0120078

(51) Int. Cl. G10L 19/00; G10L 21/02; H04R 5/00

(52) U.S. Cl. 704/500; 381/17; 704/E21.001; 704/E19.005; 375/240; 381/23

(57) ABSTRACT

Provided is an encoding apparatus for a High Quality Multi-channel Audio Codec (HQMAC) and a decoding apparatus for the HQMAC. The encoding/decoding apparatuses for the HQMAC may perform a High Quality Multi-channel Audio Codec-Channel Based (HQMAC-CB) encoding or an HQMAC-CB decoding in accordance with characteristics of inputted audio signals to provide compatibility with a lower channel.

### CROSS-REFERENCE TO RELATED APPLICATIONS

This application claims the benefit of Korean Patent Application Nos. 10-2009-0055757, filed on Jun. 23, 2009, and 10-2009-0120078, filed on Dec. 4, 2009, in the Korean Intellectual Property Office, the disclosures of which are incorporated herein by reference.

### BACKGROUND

1. Field of the Invention

Embodiments of the present invention relate to encoding and decoding apparatuses for a High Quality Multi-channel Audio Codec (HQMAC), which may differently perform an audio signal coding in accordance with characteristics of inputted audio signals.

2. Description of the Related Art

Multi-channel audio signals such as 5.1 channel signals may be effectively transmitted through a broadcasting network, or may be subjected to a compression and encoding/decoding to be stored in an optical media such as a Digital Video Disk (DVD) or a Blue-ray disk.

The compression and encoding/decoding may be performed based on a perceptual audio coding technology using a psychoacoustic audio model and time/frequency conversion. In this instance, a channel coding technology using correlation between the multi-channel audio signals and neighboring signals may be additionally used. For example, as examples of the channel coding technology, an Audio Compression (AC)-3 or Dolby Digital, a Digital Theater System (DTS), Advanced Audio Coding (AAC) standardized in a Moving Picture Experts Group (MPEG) scheme and the like may be given. These channel coding technologies are adopted in domestic and foreign digital broadcasting standards and optical media storage format standards such as DVD, DVD-Audio, DVD-High Definition (HD), Blue-ray, and the like.

Recently, to provide multi-channel audio services in an environment having a limited bandwidth such as in a mobile broadcasting, an Internet Protocol television (IPTV), and the like, a research for a spatial audio coding technology that may express, as parameters, spatial cue information of the multi-channel audio signals and compress the expressed information has been made. The spatial audio coding technology may be a technology that may down-mix the multi-channel audio signals into mono-signals or stereo-signals, and may code, as supplement information, spatial parameters required for restoring the multi-channel audio signals. As a representative example of the spatial audio coding technology, an MPEG Surround Sound scheme may be given.

To express realistic audio signals having high presence to be replayed in a realistic broadcasting environment such as a three-dimensional (3D) TV, an ultra high definition (UHD) TV, and the like, a loudspeaker having at least ten-channels may be required. The 5.1 channels applied to the HDTV and the DVD have been widely used, however, a maximum of 7.1 channels are supported in the DVD-HD standard and the Blue-ray standard. In addition, to provide a sound field effect in a large-scale audio space such as a theater and the like, a loudspeaker having 100 channels or more may be used.

However, Most TVs and radios used in general homes may use a loudspeaker having two channels, and the 5.1 channels may be replayed due to the commercialization of HDTV and the DVD.

As an example, when compressing the multi-channel audio signals of at least ten channels using a channel encoder illustrated in FIG. 1, it may be difficult to maintain compatibility with a terminal that replays 5.1 channels.

Thus, there is a need for multi-channel audio encoding/decoding technologies that may provide compatibility with a lower channel while compressing the multi-channel audio signals having at least ten channels.

### SUMMARY

An aspect of the present invention provides an encoding apparatus for a High Quality Multi-channel Audio Codec (HQMAC) that may differently perform an encoding in accordance with characteristics of audio signals to provide compatibility with a lower channel, and a decoding apparatus for the HQMAC.

According to an aspect of the present invention, there is provided an encoding apparatus for a High Quality Multi-channel Audio Codec (HQMAC), the encoding apparatus including: a High Quality Multichannel Audio Codec-Channel Based (HQMAC-CB) encoding unit to perform an HQMAC-CB encoding on inputted audio signals based on characteristics of the audio signals; and a High Quality Multichannel Audio Codec-Object Based (HQMAC-OB) encoding unit to perform an HQMAC-OB encoding on the audio signals based on the characteristics of the audio signals.

In this instance, when the inputted audio signals are multi-channel audio signals, the HQMAC-CB encoding unit may perform the HQMAC-CB encoding on the multi-channel audio signals to generate a bitstream, and when the inputted audio signals are multi-object audio signals, the HQMAC-OB encoding unit may perform the HQMAC-OB encoding on the multi-object audio signals to generate a bitstream.

Also, the HQMAC-CB encoding unit may include a high efficiency channel encoder to down-mix the multi-channel audio signals to generate first down-mixed signals, and to encode a spatial parameter extracted from the multi-channel audio signals to generate a second enhancement layer bitstream.

Also, the HQMAC-CB encoding unit may further include a channel mixing unit to down-mix the first down-mixed signals to generate second down-mixed signals, and to mix the first down-mixed signals and supplement channel signals.

Also, the HQMAC-CB encoding unit may further include a first channel encoder to encode the second down-mixed signals to generate a base layer bitstream.

Also, the HQMAC-CB encoding unit may further include a second channel encoder to encode the mixed first down-mixed signals to generate a first enhancement layer bitstream.

Also, the HQMAC-OB encoding unit may include a mixing unit to mix multi-object audio signals when the inputted audio signals are the multi-object audio signals; a bitstream generation unit to encode the mixed signals to generate a base layer bitstream; and an object encoder to divide the inputted multi-object audio signals into mono-object audio signals, stereo-object audio signals, and multi-object audio signals, and to multiplex the divided audio signals using predetermined rendering information to generate an object layer bitstream.

In this instance, a first enhancement layer bitstream and a second enhancement layer bitstream, each bitstream being generated by the HQMAC-CB encoding unit, may be included in an ancillary data region in a base layer bitstream structure, and an object layer bitstream generated by the HQMAC-OB encoding unit may be included in the ancillary data region in the base layer bitstream structure.

According to an aspect of the present invention, there is provided a decoding apparatus for an HQMAC, the decoding apparatus including: an HQMAC-CB decoding unit to perform an initialization for an HQMAD-CB decoding, based on an encoding mode received from an encoding apparatus for an HQMAC; and an HQMAC-OB decoding unit to perform an initialization for an HQMAC-OB decoding, based on the encoding mode.

In this instance, the HQMAC-CB decoding unit may perform the HQMAC-CB decoding based on a bitstream layer included in a frame received from the encoding apparatus for the HQMAC, and the HQMAD-OB decoding unit may perform the HQMAD-OB decoding based on the bitstream layer.

Additional aspects, features, and/or advantages of the invention will be set forth in part in the description which follows and, in part, will be apparent from the description, or may be learned by practice of the invention.

### EFFECT

According to embodiments of the present invention, there are provided an encoding apparatus for a High Quality Multi-channel Audio Codec (HQMAC) and a decoding apparatus for the HQMAC, which may compress and restore high quality multi-channel audio signals while maintaining compatibility with a surround sound playback system such as Audio Compression (AC)-3.

Also, when restoring multi-channel audio signals, a channel enhancement scheme may be applied in a stepwise manner based on a bitstream layer, and thereby channel signals being suitable for an environment of a playback terminal may be extracted from an intermediate process of a decoding process to be used.

Also, an encoding and a decoding may be performed for each object, thereby reducing a bandwidth in a multi-channel environment.

Also, acoustic signals optimally rendered in an environment of a playback terminal may be provided, and a degree of freedom may be provided to a user to freely control audio object signals.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a 7.1 channel encoder according to a conventional art;

FIG. 2 is a diagram illustrating a configuration of an encoding apparatus for High Quality Multi-channel Audio Coding (HQMAC) according to an embodiment;

FIG. 3 is a block diagram illustrating a configuration of a High Quality Multi-channel Audio Coding-Channel Based (HQMAC-CB) encoding unit according to an embodiment;

FIG. 4 is a block diagram illustrating a configuration of a High Quality Multi-channel Audio Coding-Object Based (HQMAC-OB) encoding unit according to an embodiment;

FIGS. 5 to 7 are diagrams illustrating a structure of an HQMAC bitstream according to an embodiment;

FIG. 8 is a block diagram illustrating a configuration of an HQMAC-CB decoding unit according to an embodiment;

FIG. 9 is a block diagram illustrating a configuration of an HQMAC-OB decoding unit according to an embodiment.

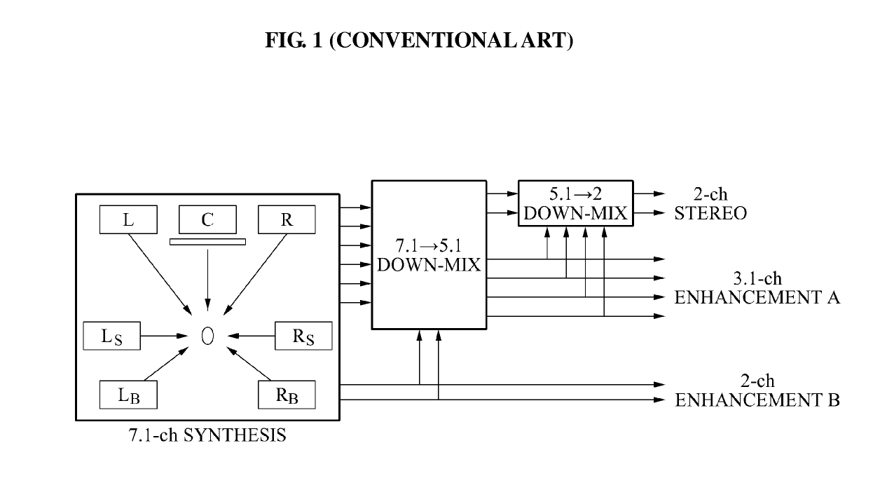

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

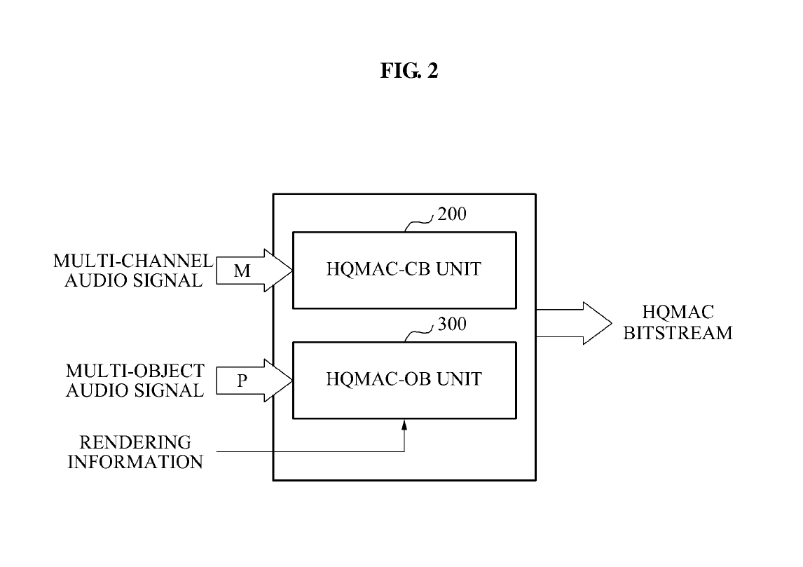

FIG. 2 is a diagram illustrating a configuration of an encoding apparatus for a High Quality Multi-channel Audio Codec (HQMAC) according to an embodiment.

Referring to FIG. 2, a High Quality Multi-channel Audio Coding-Channel Based (HQMAC-CB) encoding or a High Quality Multi-channel Audio Coding-Object Based (HQMAC-OB) encoding may be performed on audio signals inputted to the encoding apparatus for HQMAC, based on characteristics of the audio signals.

For example, when the inputted audio signals are multi-channel (M channels) audio signals, the encoding apparatus for HQMAC may perform the HQMAC-CB encoding on the multi-channel audio signals. Also, when the inputted audio signals are multi-object (P objects) audio signals, the encoding apparatus for HQMAC may perform the HQMAC-OB encoding on the multi-object audio signals. The encoding apparatus for HQMAC may perform the HQMAC-CB encoding and the HQMAC-OB encoding based on the characteristics of the inputted audio signals to generate an HQMAC bitstream.

Also, when the inputted audio signals are signals where the multi-audio signals and the multi-object audio signals are mixed, the encoding apparatus for HQMAC may perform both the HQMAC-CB encoding and the HQMAC-OB encoding to generate the HQMAC bitstream.

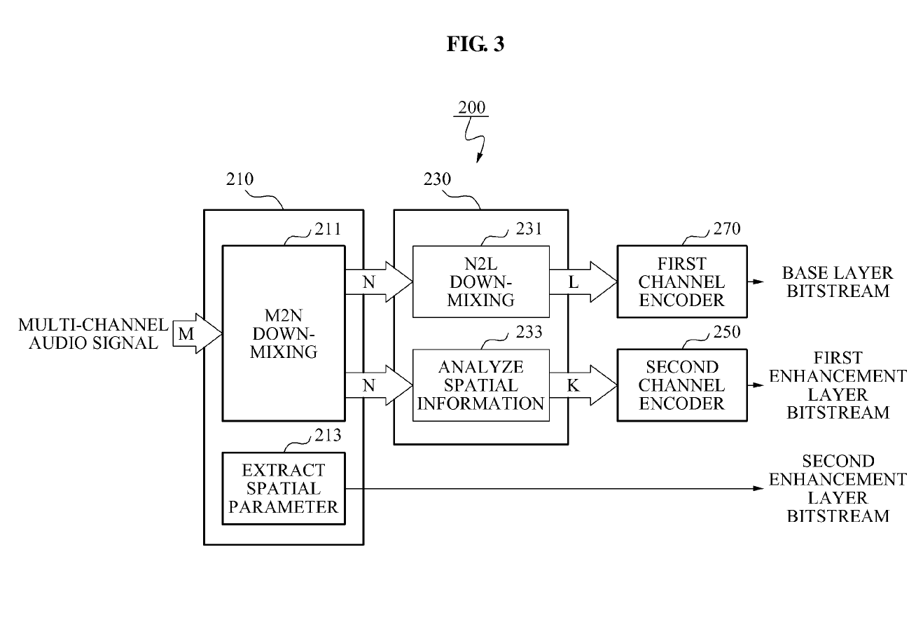

Hereinafter, a High Quality Multi-channel Audio Coding-Channel Based (HQMAC-CB) encoding unit will be described with reference to FIG. 3.

FIG. 3 is a block diagram illustrating a configuration of an HQMAC-CB encoding unit 200 according to an embodiment.

Referring to FIG. 3, the HQMAC-CB encoding unit 200 includes a High Efficiency Channel Encoder (HECE) 210, a channel mixing unit 230, a second channel encoder 250, and a first channel encoder 270.

The HECE 210 may down-mix inputted multi-channel (M channels) audio signals into N channels, that is, perform an M2N down mixing 213 to thereby generate first down-mixed signals. For example, the HECE 210 may down-mix 22.2 channels (M=24) into 10.2 channels (N=12) to configure second down-mixed signals.

Also, the HECE 210 may extract spatial cue parameters by analyzing spatial cue information from the multi-channel audio signals. In this instance, the spatial parameters may include parameters required for restoring, to multi-channel audio signals of M channels, the first down-mixed signals having been down-mixed into the N channels.

Also, the HECE 210 may encode the multi-channel audio signals to generate a second enhancement layer bitstream. The channel mixing unit 230 may down-mix, into L channels, the first down-mixed signals having been down-mixed to the N channels, that is, perform an N2L down-mixing 231, to thereby generate second down-mixed signals. For example, the channel mixing unit 230 may down-mix 10.2 channels (N=12) to 5.1 channels (L=6) to generate second down-mixed signals.

In this instance, the channel mixing unit 230 may perform a supplement channel signal synthesis 233 on the first down-mixed signals. The supplement channel signal synthesis may be required for restoring, to the first down-mixed signals of N channels, the second down-mixed signals having been down-mixed to the L channels. Through this, the first down-mixed signals of the N channels may be mixed to K channels. Here, a number (K) of channels of the supplement channel signals may be equal to or less than a difference (N-L) between a number (N) of channels of the second down-mixed signals and a number (L) of channels of the first down-mixed signals.

The second channel encoder 250 may encode the mixed K channel signals to generate a first enhancement layer bitstream. Here, the first down-mixed signals may include the mixed K channel signals and the L channel down-mixed signals generated in the process of the N2L down-mixing 231. In this instance, the second channel encoder 250 may generate the first enhancement layer bitstream using a High Quality Channel Encoding (HQCE) technology such as an Audio Compression (AC)-3 or an Advanced Audio Coding (AAC). For example, when a channel configured by a base layer bitstream is 5.1 channels (L=6), and a channel configured by the first enhancement layer bitstream is 5.1 channels (K=6), 10.2 channels (N=12) may be configured by the base layer bitstream and the first enhancement layer bitstream.

The first channel encoder 270 may encode the second down-mixed signals to generate the base layer bitstream. Here, the channel configured by the base layer bitstream may be configured as the 5.1 channels (L=6).

In this instance, as the first channel encoder 270, a multi-channel encoder such as a 5.1 channel encoder may be used. Thus, the generated first and second enhancement layer bitstreams may be multiplexed in the base layer bitstream. Through this the above multiplexing, even in a multi-channel decoder capable of decoding only the base layer bitstream, bitstreams generated by performing a compression and coding on audio signals of at least ten channels may be processed.

Thus, the encoding apparatus for HQMAC may transmit, to a decoding apparatus for HQMAC, the generated first and second enhancement layer bitstreams and HQMAC bitstreams including the base layer bitstream.

Also, one or both of the first enhancement layer bitstream and the second enhancement layer bitstream may not exist. Also, in the encoding apparatus for HQMAC, a number of channels of each of the first and second enhancement layer bitstreams may be determined. Thus, the determined number of channels may be included in a header of the HQMAC bitstream.

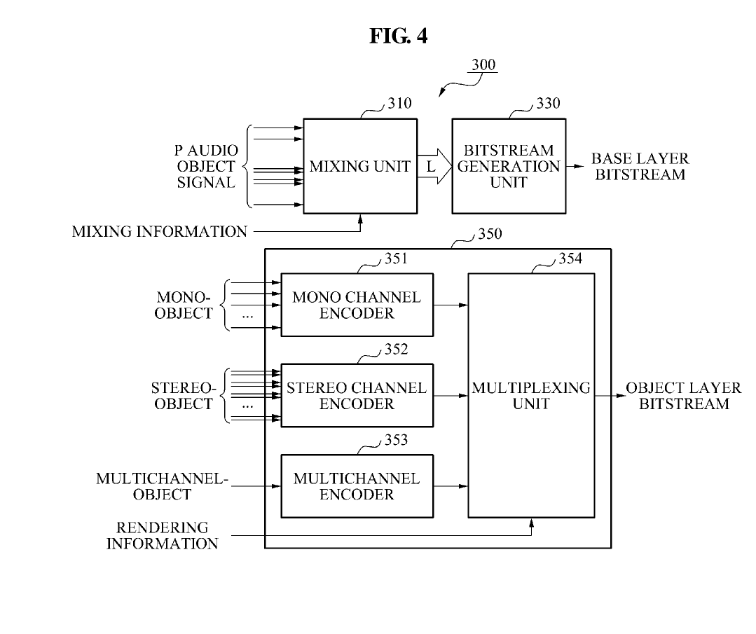

FIG. 4 is a block diagram illustrating a configuration of a High Quality Multi-channel Audio Coding-Object Based (HQMAC-OB) encoding unit according to an embodiment.

Referring to FIG. 4, an HQMAC-OB encoding unit 300 includes a mixing unit 310, a bitstream generation unit 330, and an object encoder 350.

The mixing unit 310 may mix multi-channel audio signals of P channels to L channels using mixing information inputted from the outside.

The bitstream generation unit 330 may code the mixed L channel audio signals to generate a base layer bitstream. In this instance, the bitstream generation unit 330 may generate the base layer bitstream using a multi-channel encoder such as a 5.1 channel encoder and the like.

The object encoder 350 may divide multi-object audio signals of P channels into mono-object audio signals, stereo-object audio signals, and multi-channel object audio signals, respectively, and perform an encoding on each of the divided object audio signals.

For example, the mono-object audio signals may be encoded by a mono-channel encoder 351, the stereo-object audio signals may be encoded by a stereo-channel encoder 352, and the multi-channel object audio signals may be encoded by a multi-channel encoder 353. In this instance, the mono-channel encoder 351, the stereo-channel encoder 352, and the multi-channel encoder 353 may encode the divided object audio signals using a coding technology such as Audio Compression (AC)-3, AAC, an MP 3, and the like.

Thereafter, a multiplexing unit 354 may multiplex encoded object coding bitstreams together with rendering information to generate object layer bitstreams. Here, the object coding bitstreams may include the coded mono-object audio signals, the coded stereo-object audio signals, and the coded multi-channel object audio signals.

In this instance, the rendering information may be determined in accordance with a playback environment such as a headphone, a loudspeaker, a number of loudspeakers, a position of the loudspeaker, and the like. Also, the rendering information may include information capable of directly expressing a position hypothetically disposed on a three-dimensional (3D) space.

Thereafter, the encoding apparatus for HQMAC may transmit, to the decoding apparatus for HQMAC, the HQMAC bitstreams including the generated object layer bitstreams and the base layer bitstreams. Here, the HQMAC bitstreams may be configured of an HQMAC header and an HQMAC frame. In this instance, the HQMAC header may include decoding information required for initializing a decoder, such as an encoding mode, a number of channels, quantized bits, quantized frequencies, supplement layer configuration information, a number of objects, and the like.

Here, the encoding mode may include information indicating where the bitstreams generated in the encoding apparatus for HQMAC are subjected to the HQMAC-CB encoding or the HQMAC-OB encoding. Also, the supplement layer configuration information may indicate whether the bitstreams transmitted from the encoding apparatus for HQMAC include the object layer bitstreams or the first and second enhancement layer bitstreams.

In addition, as the object encoder 350, a parameter-based multi-object audio encoder such as with a Moving Picture Experts Group (MPEG) Spatial Audio Object Coding (SAOC) technology may be used. In this instance, down-mixed signals may be directly generated by the object encoder 350, or may be the L channel object audio signals outputted from the mixing unit 310. As a result, the object coding bitstreams generated by the object encoder 350 may include object side information configured of the down-mixed signals and spatial cue parameters.

As described above, the HQMAC-CE encoding unit 200 may generate the base layer bitstream, the first enhancement layer bitstream, and the second enhancement layer bitstream, and the HQMAC-OB encoding unit 300 may generate the base layer bitstream and the object layer bitstream. In this instance, when the base layer bitstreams generated in the HQMAC-CB encoding unit 200 and the HQMAC-OB encoding unit 300 are the same as bitstreams (for example, 5.1 channel) of a general L channel, bitstreams supplemented in the base layer bitstreams may be positioned in the ancillary data region of a structure of the base layer bitstream.

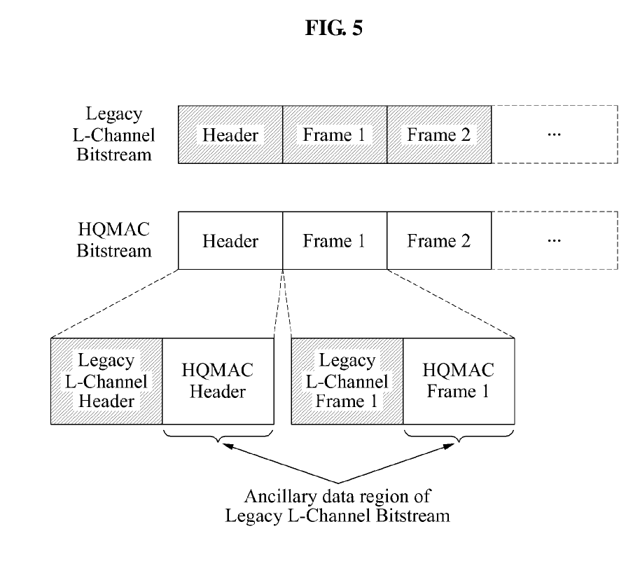

Specifically, as illustrated in FIG. 5, an HQMAC header and HQMAC frame data constituting an HQMAC bitstream may be respectively positioned in an ancillary data region of each of a legacy L-channel header and a legacy L-channel frame. Through this, since a 5.1 channel decoder capable of decoding a base layer bitstream ignores the ancillary data region, the base layer bitstream may be analyzed within an HQMAC bitstream to play back 5.1 channel audio signals.

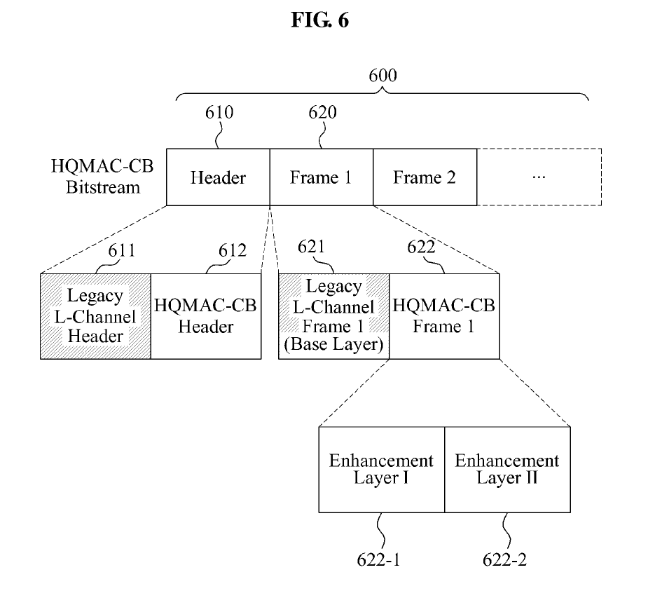

More specifically, in FIG. 6, an HQMAC-CB bitstream 600 generated by the HQMAC-CB encoding unit 200 may include an HQMAC-CB header and an HQMAC-CB frame. In this instance, the HQMAC-CB header 610 may include a base layer header 611 and an HQMAC-CB header 613.

Also, the HQMAC-CB frame 620 includes a base layer frame 621 and an HQMAC-CB frame 622. In this instance, the base layer header 611 and the base layer frame 621 may have a structure of an L-channel bitstream (for example, 5.1 channel). Thus, the HQMAC-CB header 612 and the HQMAC-CB frame 622 may be positioned in an ancillary data region of the L-channel bitstream structure. Here, the HQMAC-CB frame 622 may include a first enhancement layer bitstream 621-1 and a second enhancement layer bitstream 621-2.

In this instance, at least one of the first enhancement layer bitstream and the second enhancement layer bitstream may be included in the HQMAC-CB frame 622, or both the first enhancement layer bitstream and the second enhancement layer bitstream may be omitted from the HQMAC-CB frame 622. Specifically, the first and second enhancement layer bitstreams may be selectively used in accordance with characteristics of inputted audio signals and a user's selection.

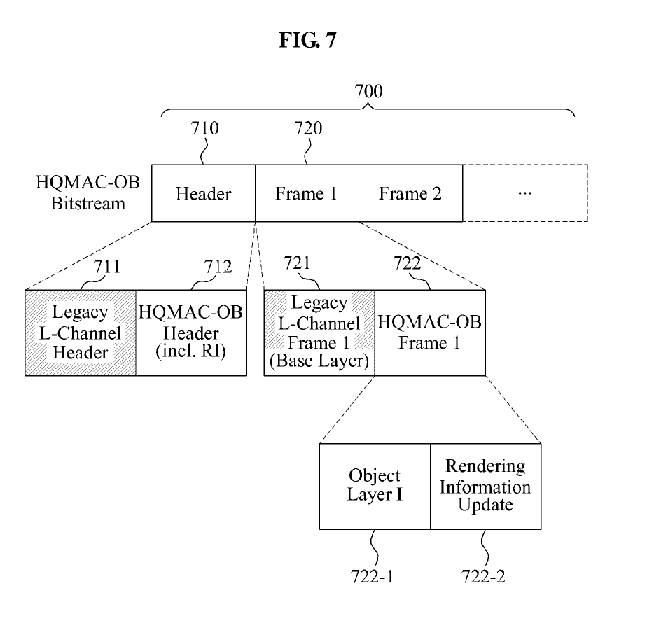

Similarly, referring to FIG. 7, an HQMAC-OB bitstream 700 generated by the HQMAC-OB encoding unit 300 may include an HQMAC-OB header 710 and an HQMAC-OB frame 720. In this instance, as illustrated in FIG. 5, the HQMAC-OB header 710 and the HQMAC-OB frame 720 may be positioned in an ancillary data region of a base layer bitstream.

Also, the HQMAC-OB header 710 may include decoding information for HQMAC-OB decoding, and rendering information (RI). Here, the rendering information (RI) may be used for rendering decoded object audio signals into a multi-channel loudspeaker.

Also, the rendering information (RI) may be updated over time. Thus, the updated rendering information 722-2 may be positioned subsequent to an object layer bitstream 722-1. In this instance, since the rendering information does not need to be changed for each of all frames, whether a change in the rendering information occurs may be indicated by using a flag only when the change occurs.

Also, when both the HQMAC-CB encoding unit and the HQMAC-OB encoding unit are simultaneously used, there may exist both the HQMAC-CB header/frame and the HQMAC-OB header/frame.

Hereinafter, a decoding apparatus for HQMAC will be described. The decoding apparatus for HQMAC may include an HQMAC-CB decoding unit 800 and an HQMAC-OB decoding unit 900.

In this instance, the decoding apparatus for HQMAC may receive, from the encoding apparatus for HQMAC, the HQMAC bitstream including the HQMAC header and the HQMAC frame. Thereafter, the decoding apparatus for HQMAC may perform an HQMAC-CB decoding or an HQMAC-OB decoding on the received HQMAC bitstream based on an encoding mode included in the HQMAC header.

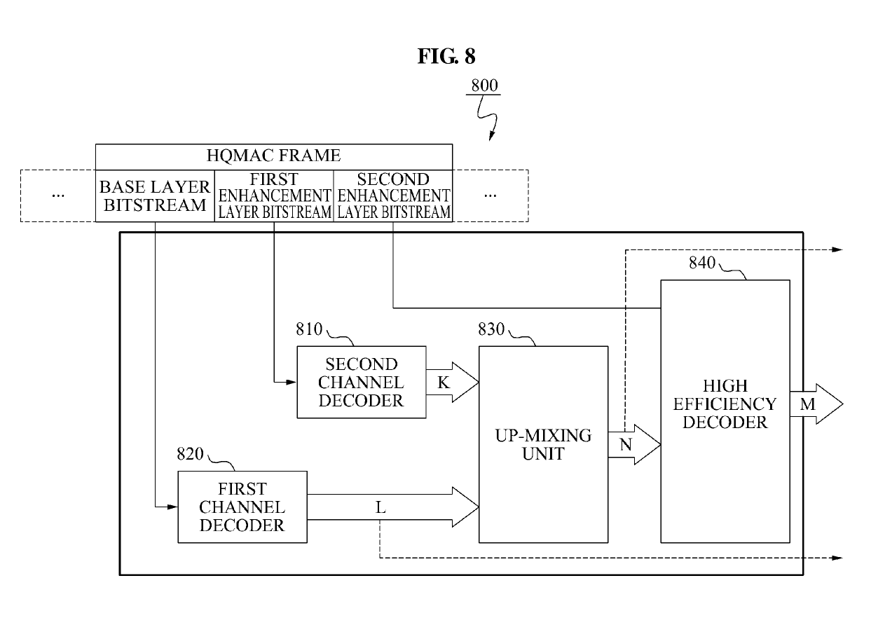

FIG. 8 is a block diagram illustrating a configuration of an HQMAC-CB decoding unit according to an embodiment.

Referring to FIG. 8, the HQMAC-CB decoding unit 800 includes a second channel decoder 810, a first channel decoder 820, an up-mixing unit 830, and a high efficiency channel decoder 840. In this instance, the HQMAC-CB decoding unit 800 may decode an HQMAC bitstream based on a bitstream layer included in the received HQMAC frame. In a case of HQMAC-CB, the bitstream layer may include a base layer bitstream, a first enhancement layer bitstream, and a second enhancement layer bitstream.

When an encoding mode is the HQMAC-CB, the second channel decoder 810 may decode first enhancement layer data included in the HQMAC frame to thereby restore mixed K-channel signals. Here, as the second channel decoder 810, a general high quality channel decoder such as AAC or AC-3 may be used.

For example, when the HQMAC bitstream transmitted from the decoding apparatus for HQMAC is encoded by the HQMAC-CB encoding unit 200, the second channel decoder 810 may decode the first enhancement layer data to thereby restore the mixed K-channel signals. Specifically, first down-mixed signals having N channels may be restored using the K channels mixed using the second channel decoder 810 and the L channels mixed using the first channel decoder 820.

The first channel decoder 820 may decode the base layer bitstream included in the HQMAC frame to thereby restore second down-mixed signals having the L channels. Specifically, the base layer bitstream may restore the second down-mixed signals having the L channels, using the first channel decoder 820. Here, as the second channel decoder 810, a general 5.1 channel decoder may be used.

The up-mixing unit 830 may up-mix K channel signals that are mixed using the second down-mixed signals (L channels) and the second channel decoder 810 to thereby restore first down-mixed signals having N channels.

The high efficiency channel decoder 840 may restore multi-channel (M channels) audio signals using the first down-mixed signals and the second enhancement layer bitstream included in the HQMAC frame. In this instance, the first down-mixed signals of N channels having been restored in the up-mixing unit 830 and the second down-mixed signals of L channels having been restored in the first channel decoder 820 may be directly outputted. Specifically, the first down-mixed signals and the second down-mixed signals may be output signals of the HQMAC-CB decoding unit 800.

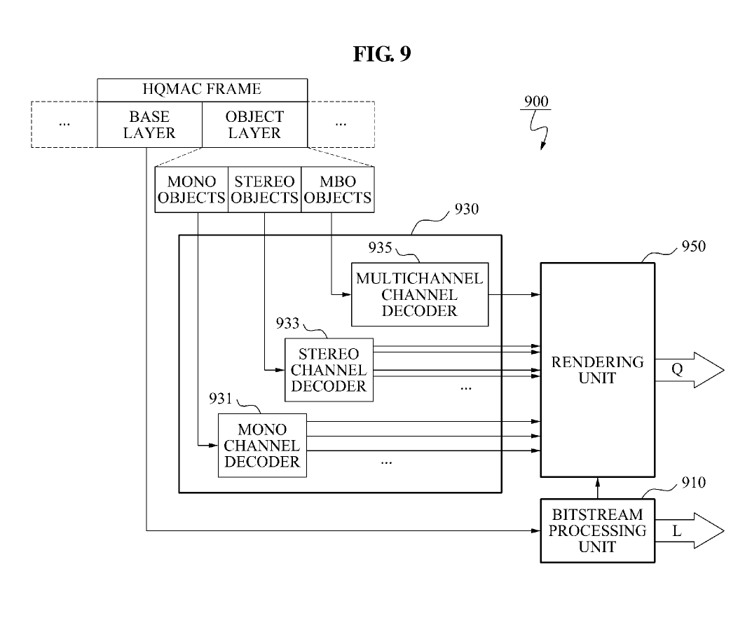

FIG. 9 is a block diagram illustrating a configuration of an HQMAC-OB decoding unit 900 according to an embodiment.

Referring to FIG. 9, the HQMAC-OB decoding unit 900 includes a bitstream processing unit 910, an object decoder 930, and a rendering unit 950. In this instance, the HQMAC-OB decoding unit 900 may decode an HQMAC bitstream based on a bitstream layer included in a received HQMAC frame. In a case of HQMAC-OB, the bitstream layer may include a base layer bitstream and an object layer bitstream.

The bitstream processing unit 910 may restore, using the base layer bitstream, the audio signals that have been mixed into L channels in the HQMAC-OB encoding unit 300. For example, the bitstream processing unit 910 may restore the audio signals having been mixed into L channels, using a 5.1 channel decoder.

The object decoder 930 may respectively decode encoded bitstreams for each object that are included in the object layer bitstream to thereby restore multi-object audio signals. Specifically, the object decoder 930 may restore the multi-object audio signals without using the base layer bitstream. Here, the encoded bitstreams for each object may include an encoded mono-object bitstream, an encoded stereo-object bitstream, and an encoded multi-channel object bitstream.

For example, a mono-channel decoder 931 may decode the encoded mono-object bitstream, a stereo-channel decoder 933 may decode the encoded stereo-object bitstream, and a multi-channel decoder 934 may decode the encoded multi-channel object bitstream.

The rendering unit 950 may render each of the mono-object bitstream, the stereo-object bitstream, and the multi-channel object bitstream using rendering information to thereby generate output signals capable of being replayed. For example, the rendering unit 950 may generate loudspeaker signals of Q channels as the output signals. In this instance, the rendering information may be included in the HQMAC bitstream transmitted from the encoding apparatus for HQMAC.

Also, the rendering unit 950 may selectively use decoded audio signals from the base layer bitstream included in the HQMAC frame. Specifically, the rendering unit 950 may use audio signals mixed into the L channels having been restored in the bitstream processing unit 910.

Also, when both the HQMAC-CB bitstream and the HQMAC-OB bitstream are included in the inputted HQMAC bitstream, output signals having been subjected to the HQMAC-CB decoding and the HQMAC-OB decoding may be multiplexed to be outputted.

As described above, for convenience of description, the HQMAC-CB bitstream and the HQMAC-OB bitstream are separately described, however, both the HQMAC-CB bitstream and the HQMAC-OB bitstream may signify the HQMAC bitstream. Specifically, the HQMAC-CB bitstream may be the HQMAC bitstream generated by the HQMAC-CB encoding, and the HQMAC-OB bitstream may be HQMAC bitstream generated by the HQMAC-OB encoding.

Also, as described in FIG. 3, the HQMAC-CB encoding may be performed in the HQMAC-CB encoding unit, using the high efficiency channel encoder and the second channel encoder together with the first channel encoder, however, this may be merely an example. Thus, the high efficiency encoder and the second channel encoder may be selectively used.

Specifically, the HQMAC-CB encoding may be performed using at least one of the high efficiency channel encoder and the second channel encoder, or may be performed only using the first channel encoder without using both the high efficiency channel encoder and the second channel encoder.

As described above, when the high efficiency channel encoder and the second channel encoder are selectively used, the channel mixing unit may selectively use the down-mixing. Specifically, when the high efficiency channel encoder is not used, the channel mixing unit may down-mix inputted multi-channel (M channels) audio signals into L channels.

Similarly, the HQMAC-CB decoding may be performed using at least one of the high efficiency channel decoder and the second channel decoder, or may be performed only using the first channel decoder without using both the high efficiency channel decoder and the second channel decoder. In this instance, when the high efficiency channel decoder is not used, the up-mixing unit may up-mix, into M channels, the first down-mixed signals having been mixed with the second down-mixed signals.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An encoding apparatus for a High Quality Multi-channel Audio Codec (HQMAC), the encoding apparatus comprising:
a High Quality Multichannel Audio Codec-Channel Based (HQMAC-CB) encoding unit to perform an HQMAC-CB encoding on inputted audio signals based on characteristics of the audio signals; and
a High Quality Multichannel Audio Codec-Object Based (HQMAC-OB) encoding unit to perform an HQMAC-OB encoding on the audio signals based on the characteristics of the audio signals.

2. The encoding apparatus of claim 1, wherein, when the inputted audio signals are multi-channel audio signals, the HQMAC-CB encoding unit performs the HQMAC-CB encoding on the multi-channel audio signals to generate a bitstream, and when the inputted audio signals are multi-object audio signals, the HQMAC-OB encoding unit performs the HQMAC-OB encoding on the multi-object audio signals to generate a bitstream.

3. The encoding apparatus of claim 2, wherein the HQMAC-CB encoding unit comprises:
a high efficiency channel encoder to down-mix the multi-channel audio signals to generate first down-mixed signals, and to encode a spatial parameter extracted from the multi-channel audio signals to generate a second enhancement layer bitstream.

4. The encoding apparatus of claim 3, wherein the HQMAC-CB encoding unit further comprises:
a channel mixing unit to down-mix the first down-mixed signals to generate second down-mixed signals, and to mix the first down-mixed signals and supplement channel signals.

5. The encoding apparatus of claim 4, wherein the HQMAC-CB encoding unit further comprises:
a first channel encoder to encode the second down-mixed signals to generate a base layer bitstream.

6. The encoding apparatus of claim 5, wherein each of a channel configured by the base layer bitstream, a channel configured by a first enhancement layer bitstream, and a channel configured by the second enhancement layer bitstream is configured of multi-channels different from each other.

7. The encoding apparatus of claim 4, wherein the HQMAC-CB encoding unit further comprises:
a second channel encoder to encode the mixed first down-mixed signals to generate a first enhancement layer bitstream.

8. The encoding apparatus of claim 1, wherein the HQMAC-OB encoding unit comprises:
a mixing unit to mix multi-object audio signals when the inputted audio signals are the multi-object audio signals;
a bitstream generation unit to encode the mixed signals to generate a base layer bitstream; and
an object encoder to divide the inputted multi-object audio signals into mono-object audio signals, stereo-object audio signals, and multi-object audio signals, and to multiplex the divided audio signals using predetermined rendering information to generate an object layer bitstream.

9. The encoding apparatus of claim 8, wherein the mixing unit mixes the multi-object audio signals into a 5.1 channel signal using mixing information received from an outside.

10. The encoding apparatus of claim 1, wherein a first enhancement layer bitstream and a second enhancement layer bitstream, each bitstream being generated by the HQMAC-CB encoding unit, are included in an ancillary data region in a base layer bitstream structure, and an object layer bitstream generated by the HQMAC-OB encoding unit is included in the ancillary data region in the base layer bitstream structure.

11. The encoding apparatus of claim 10, wherein:
the HQMAC-CB encoding unit configures an HQMAC-CB header and an HQMAC-CB frame using the base layer bitstream and the first and second enhancement layer bitstreams to transmit the configured HQMAC-CB header and HQMAC-CB frame, and
the HQMAC-OB encoding unit configures an HQMAC-OB header and an HQMAC-OB frame using the base layer bitstream and the object layer bitstream to transmit the configured HQMAC-OB header and HQMAC-OB frame.

12. The encoding apparatus of claim 11, wherein, when the audio coding is performed on the audio signals using both the HQMAC-CB encoding unit and the HQMAC-OB encoding unit, a bitstream generated by the performed audio coding includes the header and frame of each of the HQMAC-CB encoding and the HQMAC-OB encoding, and the HQMAC-CB header or the HQMAC-OB header includes decoding information used for decoding the bitstreams generated by the HQMAC-CB encoding unit or the HQMAC-OB encoding unit.

13. A decoding apparatus for an HQMAC, the decoding apparatus comprising:
an HQMAC-CB decoding unit to perform an initialization for an HQMAD-CB decoding, based on an encoding mode received from an encoding apparatus for an HQMAC; and
an HQMAC-OB decoding unit to perform an initialization for an HQMAC-OB decoding, based on the encoding mode.

14. The decoding apparatus of claim 13, wherein:
the HQMAC-CB decoding unit performs the HQMAC-CB decoding based on a bitstream layer included in a frame received from the encoding apparatus for the HQMAC, and
the HQMAD-OB decoding unit performs the HQMAD-OB decoding based on the bitstream layer.

15. The decoding apparatus of claim 13, wherein the HQMAC-CB decoding unit includes:
a first channel decoder to decode a base layer bitstream included in a frame transmitted from the encoding apparatus for the HQMAC to restore second down-mixed signals.

16. The decoding apparatus of claim 13, wherein the HQMAC-CB decoding unit includes:
a second channel decoder to decode a first enhancement layer bitstream included in the frame to restore mixed first down-mixed signals.

17. The decoding apparatus of claim 16, wherein the HQMAC-CB decoding unit further includes:
an up-mixing unit to up-mix the restored second down-mixed signals using the first down-mixed signals and a base layer bitstream included in the frame to restore the first down-mixed signals.

18. The decoding apparatus of claim 16, further comprising:
a high efficiency channel decoder to restore multi-channel audio signals using the first down-mixed signals and a second enhancement layer bitstream included in the frame.

19. The decoding apparatus of claim 18, wherein the HQMAC-OB decoding unit includes:
a bitstream processing unit to restore audio signals mixed into a second channel, using a base layer bitstream included in a frame received from the HQMAC apparatus; and
an object decoder to restore a bitstream of each of a mono-object, a stereo-object, and a multi-object.

20. The decoding apparatus of claim 13, wherein, when both an HQMAC-CB bitstream and an HQMAC-OB bitstream are included in an HQMAC bitstream inputted from the decoding apparatus for the HQMAC, the HQMAD-CB decoding unit performs the HQMAD-CB decoding on the HQMAC-CB bitstream to multiplex output signals, and the HQMAD-OB decoding unit performs the HQMAD-OB decoding on the HQMAC-OB bitstream to multiplex output signals.
